(19) United States
(12) Patent Application Publication
(10) Pub. No.: US 2012/0112129 A1
(43) Pub. Date: May 10, 2012

(54) GREEN EMITTING MATERIAL

(75) Inventors: Andreas Tuecks, Aachen (DE); Peter J. Schmidt, Aachen (DE); Baby-Seriyati Schreinemacher, Eynatten (BE)

(73) Assignee: KONINKLIJKE PHILIPS ELECTRONICS N.V., EINDHOVEN (NL)

(21) Appl. No.: 13/381,391

(22) PCT Filed: Jun. 28, 2010
(86) PCT No.: PCT/IB2010/052940

§ 371 Date: Dec. 29, 2011

(30) Foreign Application Priority Data
Jul. 2, 2009 (EP) 09164458.3

(51) Int. Cl. C09K 11/80

(52) U.S. Cl. 252/301.4 F

(57) ABSTRACT

The invention relates to an improved green emitting material of the form M_{I}_{3-x-y}M^{II}x Si₆₋ₓAlₓO₁₂N₂:Eu_{y}, whereby M^{I} is an earth alkali metal and M^{II} is a rare earth metal or Lanthanum. This material can be made as a ceramic using a low temperature sintering step, resulting in a better and more uniform ceramic body.

### FIELD OF THE INVENTION

The present invention is directed to novel luminescent materials for light emitting devices, especially to the field of novel luminescent materials for LEDs

### BACKGROUND OF THE INVENTION

Phosphors comprising silicates, phosphates (for example, apatite) and aluminates as host materials, with transition metals or rare earth metals added as activating materials to the host materials, are widely known. As blue LEDs, in particular, have become practical in recent years, the development of white light sources utilizing such blue LEDs in combination with such phosphor materials is being energetically pursued.

Especially green emitting luminescent materials have been in the focus of interest and several materials have been proposed, e.g. US 20090033201 A1 which is incorporated by reference.

However, there is still the continuing need for green emitting luminescent materials which are usable within a wide range of applications and especially allow the fabrication of phosphor warm white pcLEDs with optimized luminous efficiency and color rendering.

### SUMMARY OF THE INVENTION

It is an object of the present invention to provide a material which is usable within a wide range of applications and especially allows the fabrication of phosphor warm white pcLEDs with optimized luminous efficiency and color rendering.

This object is solved by a material according to claim 1 of the present invention. Accordingly, a material M^{I}_{3-x-y}M^{II}ₓSi₆₋ₓAlₓO₁₂N₂:Eu_{y} is provided, whereby

M^{I} is selected from the group comprising Ca, Sr, Ba or mixtures thereof;

M^{II} is selected from the group comprising La, Ce, Pr, Nd or mixtures thereof;

x, y are independently from each other >0 and ≦1.

It should be noted that by the term “M^{I}_{3-x-y}M^{II}ₓSi₆₋ₓAlₓO₁₂N₂:Eu_{y}” especially and/or additionally any material is meant and/or included, which has essentially this composition.

The term “essentially” means especially that ≧95%, preferably ≧97% and most preferred ≧99% wt-%.

Such a material has shown for a wide range of applications within the present invention to have at least one of the following advantages:
Using the material as luminescent material, LEDs may be built which show improved lighting features, especially thermal stability.
The Material may be made at lower temperatures than many other similar materials known in the field and can be produced using bulk-techniques.
The Material has been found to have a saturated green color point especially suited for backlighting applications.
The material can be produced in high quality with commercially available cheap starting compounds like, e.g. simple carbonates, nitrides, and oxides.

According to a preferred embodiment of the present invention, x is ≧0.002 and ≦0.3, preferably ≧0.005 and ≦0.2. This has been found to be advantageous for many applications, since when x is too low, for some applications the advantages due to the easier producibility (see also below) of the material are found to be somewhat diminished, on the other hand if x is too high, the material has found for some applications to be too “glassy”.

According to a preferred embodiment of the present invention, y is ≧0.03 and ≦13.3, preferably ≧0.06 and ≦13.2.

According to a preferred embodiment, the content of Ba in M^{I} is ≧80% (mol/mol), more preferred ≧90%.

According to a preferred embodiment, the content of La in M^{II} is ≧80% (mol/mol), more preferred ≧90%.

The present invention furthermore relates to the use of the inventive material as a luminescent material.

The present invention furthermore relates to a light emitting material, especially a LED, comprising at least one material as described above.

According to a preferred embodiment of the present invention, the at least one material is at least partly provided as at least one ceramic material.

The term “ceramic material” in the sense of the present invention means and/or includes especially a crystalline or polycrystalline compact material or composite material with a controlled amount of pores or which is pore free.

The term “polycrystalline material” in the sense of the present invention means and/or includes especially a material with a volume density larger than 90 percent of the main constituent, consisting of more than 80 percent of single crystal domains, with each domain being larger than 0.5 μm in diameter and having different crystallographic orientations. The single crystal domains may be connected by amorphous or glassy material or by additional crystalline constituents.

According to a preferred embodiment, the ceramic material has a density of ≧90% and ≦100% of the theoretical density. This has been shown to be advantageous for a wide range of applications within the present invention since then the luminescence and optical properties of the at least one ceramic material may be increased.

More preferably the ceramic material has a density of ≧97% and ≦100% of the theoretical density, yet more preferred ≧98% and ≦100%, even more preferred ≧98.5% and ≦100% and most preferred ≧99.0% and ≦100%.

According to a preferred embodiment of the present invention, the glass phase ratio of the ceramic material is ≦2%, more preferred ≧0.5% to ≦1%. It has been shown in practice that materials with such a glass phase ratio show the improved characteristics, which are advantageous and desired for the present invention.

The term “glass phase” in the sense of the present invention means especially non-crystalline grain boundary phases, which may be detected by scanning electron microscopy or transmission electron microscopy. The present invention furthermore relates to a method of producing a ceramic material according to the present invention comprising a sintering step at a temperature between ≧1000° C. to ≦1400° C.

Surprisingly it has been found that (probably due to the special constitution of the material) such low temperatures are sufficient to reach a homogeneous crystalline ceramic body. This is believed to arise at least partly from the fact that for many applications in the course of the production of the material some precursor materials may act as “flux aids”, although in the end they are incorporated in the material as a whole.

Preferably the sintering step is performed at a temperature between ≧1100° C. to ≦1325° C.

According to a preferred embodiment of the present invention, the method of producing a ceramic material according to the present invention comprises the following steps:
(a) Mixing the precursor materials for the green emitting transparent ceramic material
(b) optional firing of the precursor materials, preferably at a temperature of ≧1000° C. to ≦1350° C. to remove volatile materials (such as CO₂ in case carbonates are used)
(c) optional grinding and washing
(d) optionally a first pressing step, preferably a uniaxial pressing step using a suitable powder compacting tool with a mould in the desired shape and/or a cold isostatic pressing step preferably at ≧3000 bar to ≦5000 bar.
(e) a sintering step at ≧1000° C. to ≦1400° C. in an inert or reducing atmosphere with a pressure of ≧10⁻⁷ mbar to ≦10⁴ mbar.
(f) an optional hot pressing step, preferably a hot isostatic pressing step preferably at ≧30 bar to ≦2500 bar and preferably at a temperature of ≧1000° C. to ≦1400° C. and/or a uniaxial hot-pressing step preferably at ≧100 bar to ≦2500 bar and preferably at a temperature of ≧1000° C. to ≦1300° C., whereby step (f) or parts thereof can be performed before or after step (e)
(g) optionally a post annealing step at >800° C. to <1400° C. in inert atmosphere or in a hydrogen containing atmosphere

A material and/or a light emitting device according to the present invention may be of use in a broad variety of systems and/or applications, amongst them one or more of the following:
Office lighting systems
household application systems
shop lighting systems,
home lighting systems,
accent lighting systems,
spot lighting systems,
theater lighting systems,
fiber-optics application systems,
projection systems,
self-lit display systems,
pixelated display systems,
segmented display systems,
warning sign systems,
medical lighting application systems,
indicator sign systems, and
decorative lighting systems
portable systems
automotive applications
green house lighting systems

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

### BRIEF DESCRIPTION OF THE DRAWINGS

Additional details, features, characteristics and advantages of the object of the invention are disclosed in the subclaims, the figures and the following description of the respective figures and examples, which—in an exemplary fashion—show several embodiments and examples of materials according to the invention.

FIG. 1 shows an X-ray diffraction pattern of a ceramic material according to Example I of the present invention; and

FIG. 2 shows a scanning electron micrograph of a ceramic material according to Example II of the present invention;

FIG. 3 shows an emission spectrum of a ceramic material according to Example III of the present invention; and

FIG. 4 shows a scannig electron micrograph of the ceramic material according to Example III of the present invention.

The invention will be further understood by the following Examples I to III which—in a merely illustrative fashion—shows several materials of the present invention:

### EXAMPLE I:

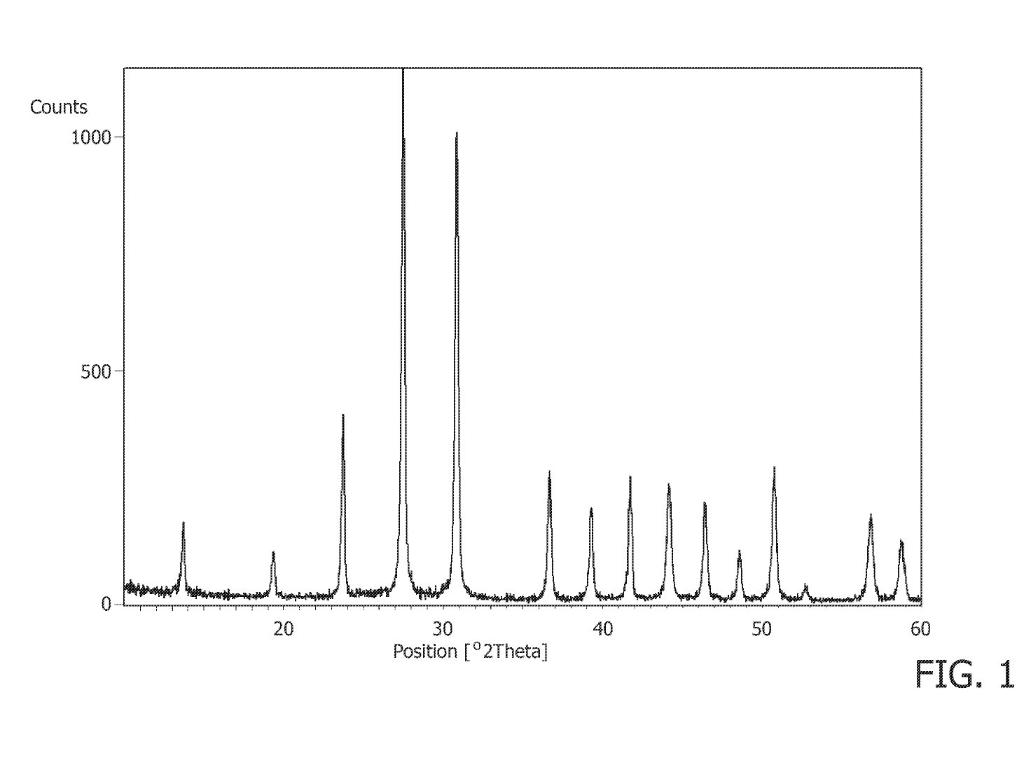

FIG. 1 refers to Ba_{2.88}La_{0.12}Si_{5.88}Al_{0.12}O₁₂N₂:Eu(2%) =Ba_{2.82}La_{0.12}Si_{5.88}Al_{0.12}O₁₂N₂:EU_{0.06} which was made the following way:

Appropriate amounts of pre-mixed sub-micron La₂O₃ and Al₂O₃ (1:1) accounting for 4 mol-% La/Al relative to Ba were added to a stoichiometric mixture of sub-micron BaSi₂O₅:Eu(2%) and BaSi₂O₂N₂:Eu(2%). After ball-milling in isopropanol, the suspension was filtered-off and dried. The resulting powder mixture was pressed into disc-shaped pre-forms and sintered in molybdenum crucibles in reducing atmosphere (N₂/H₂) at 1275° C. After sintering, the ceramics were devitrified by annealing at 1225° C. in pure nitrogen at a gas pressure of 500 bar. During devitrification glassy phases accumulate on the sample surface and can be removed in subsequent machining steps (grinding, polishing).

FIG. 1 shows an X-ray diffraction pattern of a finished ceramic (Cu-Kα radiation). Due to the high phase purity light scattering mainly results from the fact that polycrystalline ceramics consisting of grains of layered compounds are optically anisotropic. Most importantly, no residual Si₃N₄ resulting in additional scattering and residual absorption at wavelengths above 500 nm can be detected.

### EXAMPLE II:

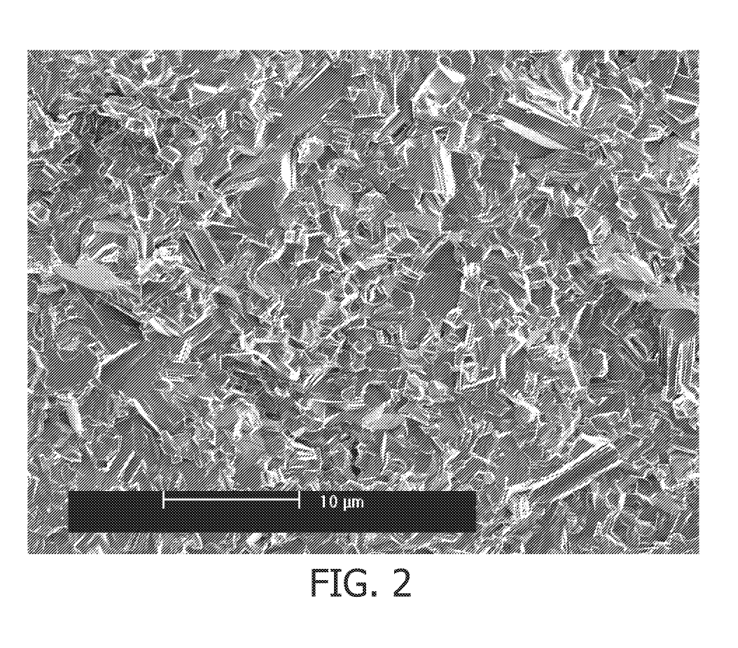

FIG. 2 refers to Ba_{2.94}La_{0.06}Si_{5.94}Al_{0.06}O₁₂N₂:Eu(2%)=Ba_{2.88}La_{0.06}Si_{5.94}Al_{0.06}O₁₂N₂:Eu_{0.06} which was made in analogous fashion according to the method of Example I.

FIG. 2 shows a scanning electron micrograph of a fracture surface. Observed grain sizes vary from 1 to 8 μm. All grains are randomly oriented within the ceramic body.

### EXAMPLE III

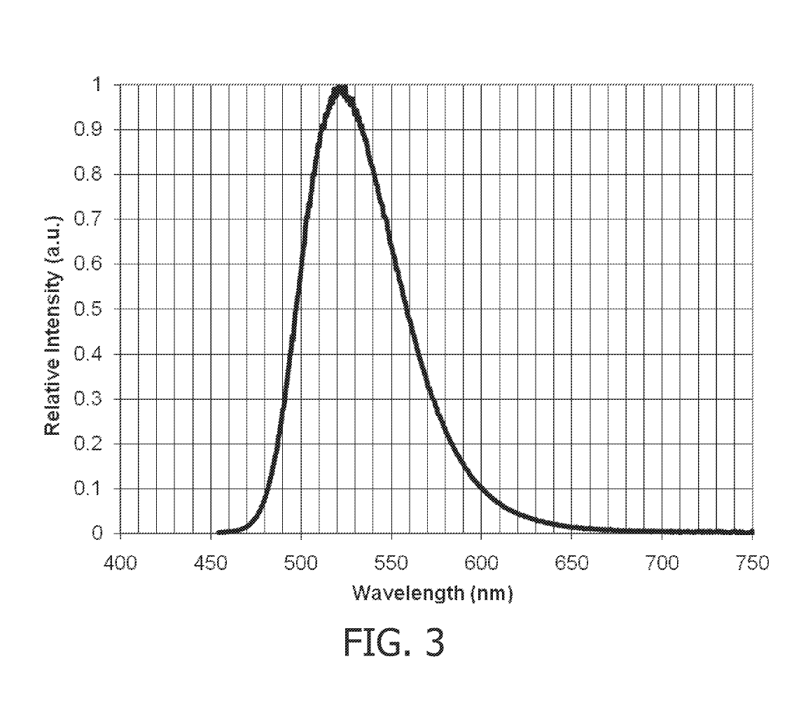

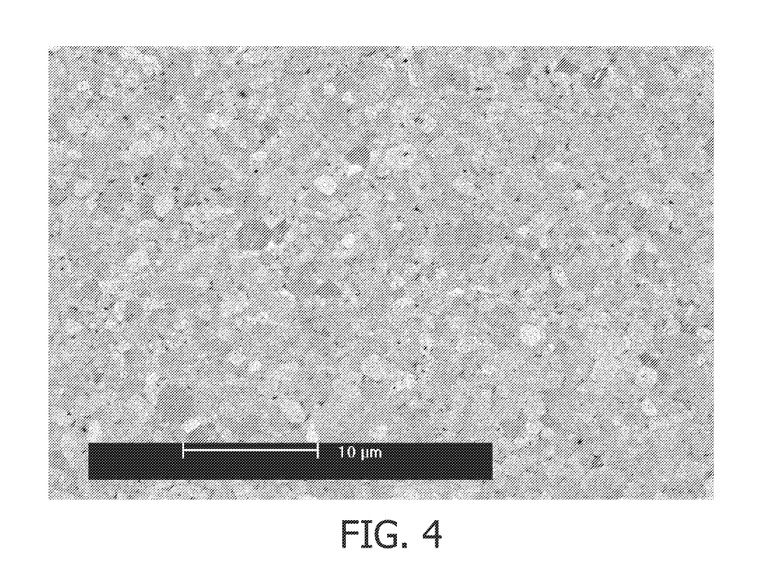

FIGS. 3 and 4 refer to Ba_{2.99}La_{0.01}Si_{5.99}Al_{0.01}O₁₂N₂:Eu(2%)=Ba_{2.93}La_{0.01}Si_{5.99}Al_{0.01}O₁₂N₂:EU_{0.06} which was made in analogous fashion according to the method of Example I.

FIG. 3 shows an emission spectrum of Example III for 430 nm excitation with an emission maximum at 522 nm and an FWHM of 61 nm.

FIG. 4 shows a scannig electron micrograph of the polished ceramic. Observed grain sizes vary from 1 to 4 μm. All grains are randomly oriented within the ceramic body.

The particular combinations of elements and features in the above detailed embodiments are exemplary only; the interchanging and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. The invention's scope is defined in the following claims and the equivalents thereto. Furthermore, reference signs used in the description and claims do not limit the scope of the invention as claimed.

1. A luminescent material having a formula of M^{I}_{3-x-y}M^{II}ₓSi₆₋ₓAlₓO₁₂N₂:Eu_{y}, wherein M^{I} is selected from the group consisting of Ca, Sr, Ba and mixtures thereof; M^{II} is selected from the group consisting of La, Ce, Pr, Nd and mixtures thereof; and
x, y are independently from each other and are >0 and ≦1.

2. The material of claim 1, wherein x is ≧0.002 and ≦0.3.

3. The material of claim 1, wherein y is ≧0.005 and ≦0.03.

4. The material of claim 1, wherein the content of Ba is M^{I} is ≧80% (mol/mol).

5. The material of claim 1, wherein the content of La in M^{II} is ≧80% (mol/mol).

6. (canceled)

7. Light emitting device, comprising the material according to claim 1.

8. The light emitting device of claim 7 wherein the at least one material is provided as a ceramic material

9. A method of producing a material according to claim 1 as a ceramic material, comprising a sintering step at a temperature between ≧1000° C. to ≦1400° C.

10. (canceled)
